(19) United States
(12) Patent Application Publication
(10) Pub. No.: US 2012/0141720 A1
(43) Pub. Date: Jun. 7, 2012

(54) Enhanced Flexible Lightweight Ballistic, Stab and Spike resistant Materials

(75) Inventors: Yves Bader, Crozet (FR); Loic Pierre Rolland, Divonne Les Bains (FR); Nicolas Pont, T. Julien En Genevois (FR); Olivier Magnin, Lausanne (CH)

(73) Assignee: E. I. DU PONT DE NEMOURS AND COMPANY, Wilmington, DE (US)

(21) Appl. No.: 13/156,689

(22) Filed: Jun. 9, 2011

Related U.S. Application Data
(60) Provisional application No. 61/353,894, filed on Jun. 11, 2010.

(51) Int. Cl. B32B 1/04; C08L 33/24

(52) U.S. Cl. 428/76; 525/190

(57) ABSTRACT

The present invention provides a use of a thermoplastic composition for manufacturing a personal protection equipment for personal ballistic, stab and knife protection, wherein the thermoplastic composition comprises at least a first thermoplastic polymer that has a melting point different to the melting point of a second thermoplastic polymer. Further, the present invention provides a personal protection equipment comprising a plurality of ballistic fabric layers, and at least one thermoplastic composition for use in ballistic applications, wherein the thermoplastic composition comprises at least a first thermoplastic polymer as set forth above.

### FIELD OF THE INVENTION

The present invention relates to enhanced, flexible light weight energy absorbing materials and methods of making them. These materials have utility in the manufacture of personal protection equipments, such as soft armor, stab and spike protection systems.

### BACKGROUND OF THE INVENTION

Aramid fibers are a class of heat-resistant and strong synthetic fibers. They are used in aerospace and military applications, for ballistic rated body armor fabrics, in car and bicycle tires, and as an non-hazardous asbestos substitute. In aramid fibers, the polymeric chain molecules are highly oriented along the fiber axis, so the strength of the chemical bond can be exploited for high-demanding applications as the ones mentioned above.

Perhaps the most prominent use of aramid fibers is in ballistic rated body armor fabrics, such as personal protection equipments (PPEs), also known colloquially as bullet-proof vests.

While the woven aramid fabrics in PPEs offer good protection against ballistic threats such as bullets, they are vulnerable to sharp and thin weapons such as knives and ice-pickles. This is due to the fact that thin weapons can pass between the fibers making up the fabric, because the fibers are pushed apart by the penetrating point of the weapon.

In an effort to improve the protection against knife and spike attacks, protective fabrics are now commonly reinforced with synthetic resins that can be of thermoplastic or thermoset nature, and which restrict relative movement of the fibres in the case of an attack. Thus, the fibers cannot be pushed apart by a thin weapon because they fixed in place by the resin.

Such a technology is described in, for example, WO 2001/037691. WO 2001/037691 discloses a protective material that is more flexible than other known protective materials and where the gain in flexibility is primarily achieved by the low denier count of the fibers used. The fibers are furthermore embedded within a support material to restrict relative movement of the fibres and thus to achieve good protection against knife or needle attacks.

However, when embedding the fibers of a protective material such as for example para-aramid fabrics (known commercially as Kevlar®, DuPont) with a polymeric resins, there is always also a rigidification that is caused by the embedding, because the embedding reduces the ability of the fibers to move relative to each other. For example, when an embedded fabric is bent, it will immediately snap back into its initial shape, in contrast to a non-embedded fabric.

Therefore, embedded fabrics are stiffer when compared to non-embedded fabrics and concurrently, personal protection equipments (PPE) manufactured from embedded fabrics are perceived as causing more discomfort. This perception leads to a reduced willingness to wear the PPE and therfore needs to be prevented by offering a more supple and/or flexible PPE.

Embedding of the fibers is commonly carried out in known manners, such as for example by lamination, calendaring or heat pressing of thermoplastic resin sheets onto the fibers. As the necessary machinery is well known and used by many manufacturers of personal protection equipment (PPE), it is desirable to reduce the modification of the embedding methods to a minimum so that eventual new resins can be applied in the same known fashion.

U.S. Pat. No. 5,866,658 disclose thermoplastic compositions which are blends of ionomers with polyamides. However, the blends are used as molded parts for automotive applications such as bumpers, fender extensions and hub caps, to improve high gloss, toughness and scratch resistance.

U.S. Pat. No. 5,859,137 discloses thermoplastic ionomers based on copolymers of ethylene and carboxylic acids as well as combinations of such ionomers with polyamides. However, such combinations are mainly useful for applications to improve impact resistance and mechanical strength.

There is therefore a strong need to further reduce the rigidity of embedded fabrics, while at the same time offering comparable protection against multiple threats such as knife, stab and needle attacks and also at the same provide a solution that can be executed on pre-existing machinery.

### BRIEF DESCRIPTION OF DRAWING

FIG. 1 represents a depiction of angles of deflection set forth in the section “Static Flexibility Test.”

### SUMMARY OF THE INVENTION

The present invention provides a use of a thermoplastic composition for manufacturing a personal protection equipment for personal ballistic, stab and knife protection, wherein the thermoplastic composition comprises at least a first thermoplastic polymer that has a melting point different to the melting point of a second thermoplastic polymer.

Further, the present invention provides a personal protection equipment comprising
a. plurality of ballistic fabric layers and;
b. at least one thermoplastic composition for use in ballistic applications, wherein the thermoplastic composition comprises at least a first thermoplastic polymer that has a melting point different to the melting point of a second thermoplastic polymer, and wherein at least one of the ballistic fabric layers is reinforced with the thermoplastic composition, and wherein the ballistic fabric layers comprising the at least one reinforced ballistic fabric layers are connected between them to form a stack of free individual ballistic fabric layers by stacking the fabric layers on top of each other and placing them into pouches or bags.

### DETAILED DESCRIPTION

The present invention solves the problems stated in the background section by providing a thermoplastic composition for the use in personal protection equipments (PPEs), wherein the thermoplastic composition comprises at least a first thermoplastic polymer that has a melting point different to the melting point of a second thermoplastic polymer, for the use in personal ballistic, stab and knife protection.

The term melting point as used in this description is intended to mean the temperature determined by means of DSC (Differential Scanning Calorimetry) at heating rates of 10K/minute, according to DIN 53765-B-10.

The thermoplastic composition according to the invention comprises a first thermoplastic polymer which can be dispersed in the continuous or co-continuous phase of the second thermoplastic polymer.

The thermoplastic composition according to the invention comprises a second thermoplastic polymer which can be dispersed in the continuous or co-continuous phase of the first thermoplastic polymer.

Preferred is a thermoplastic composition according to the invention comprising a first thermoplastic polymer dispersed in the continuous or co-continuous phase of the second thermoplastic polymer.

The term continuous phase as used in this description refers to an uninterrupted three-dimensional matrix that can be selectively dissolved using a selective solvent, as opposed to a discontinuous phase which is present or dispersed in the continuous phase in the form of particles which cannot be selectively dissolved or extracted using a selective solvent.

The term co-continuous phase as used in this description refers to the two phases which can both be extracted using a selective solvent leaving the other phase in the form of a three-dimensional network, such as for example an interpenetrating network (IPN), or to only one of the phases which can be fully extracted leaving the other one(s) as partial three-dimensional networks, as for example a semi-interpenetrating network (semi-IPN).

The first thermoplastic polymer can be present, if dispersed in the second thermoplastic polymer, as particles which can be spherical particles, elongated spheroid shapes, ellipsoids, network of branched filament-like structures, and/or complex inclusions within the first thermoplastic polymer.

Suitable diameters of the particles of the dispersed first thermoplastic polymer are diameters which are below the diameter of the fibres used in combination with the thermoplastic composition according to the invention for the use in ballistic applications.

Preferably, the diameter of the particles of the dispersed first thermoplastic polymer is in the range of 0.01 μm to 15 μm in diameter, preferably 5 μm to 15 μm in diameter and most preferably 10 μm to 15 μm.

The diameter of the particles, in the case where the dispersed first thermoplastic polymer is present as elongated spheroid shaped particles, ellipsoids, network of branched filament-like structures and/or complex inclusions, is the smallest straight line or minor axis length (average cross-sectional diameter) that can be traced within the limits of the ellipsoids and inclusions, respective is the average diameter of the elongated spheroid shaped particles.

The first thermoplastic polymer according to the present invention can be chosen from, for example, polypropylene, polypropylene copolymers, polyamide, polyamide copolymers, polyester polymers or copolymers, thermoplastic elastomeric block copolymers, for example acrylonitrile-butadiene-styrene, polyisopropene-polyethylene-butylene-polystyrene or polystyrene-polyisoprene-polystyrene block copolymers, polyether-ester block copolymers, and/or combinations thereof. Further examples can be chosen from polyvinyls, polyolefins and/or polycondensates, like for example, but not limited to, polyethylene, polyethylene copolymers, polybutylene, polybutylene copolymers, polyesters, polyurethanes, polyurethane copolymers, polyacrylonitrils, polysulfones, thermoplastic silicone copolymers and/or combinations thereof.

The first thermoplastic polymer suitable for the present invention is preferably chosen among the above mentioned polymers having a melting point in the range of 75° C. to 400° C., more preferably 110° C. to 300° C. and most preferably 140° C. to 230° C.

Preferably, the first thermoplastic polymer according to the present invention can be chosen from polypropylene, polyamide, polyester polymers or copolymers and/or combinations thereof.

More preferably, the first thermoplastic polymer according to the present invention can be chosen from polyamides, such as, but not limited to, aliphatic polyamides and/or semi-aromatic polyamides.

The polyamides suitable for the present invention can be crystalline, semi-crystalline, amorphous polyamides and/or combinations thereof.

The terms crystalline, semi-crystalline and amorphous are well-known to those skilled in the art. Amorphous polyamides refers to those polyamides which are lacking in crystallinity as shown by the lack of an endotherm crystalline melting peak in a DSC measurement according to ASTM D-3417, 10 K/minute heating rate.

The first thermoplastic polymer according to the present invention can comprise amorphous polyamides from 1 to 10 weight percent based on the total weight of the first thermoplastic polymer. More preferably, the first thermoplastic polymer according to the present invention can comprise amorphous polyamides from 1 to 30 weight percent based on the total weight of the first thermoplastic polymer. Most preferably, the first thermoplastic polymer according to the present invention can comprise amorphous polyamides from 1 to 50 weight percent based on the total weight of the first thermoplastic polymer.

Preferably, suitable aliphatic polyamides can be chosen among Nylon 6, Nylon 66, Nylon 6/66, Nylon 11, Nylon 12, Nylon 612, Nylon 13, Nylon 1010, and/or combinations thereof.

Most preferably, suitable aliphatic polyamides can be chosen among Nylon 6, Nylon 11, Nylon 12, Nylon 612, Nylon 13, Nylon 1010, and/or combinations thereof.

The second thermoplastic polymer can be present, if dispersed in the first thermoplastic polymer, as particles which can be spherical particles, elongated spheroid shapes, ellipsoids, network of branched filament-like structures, and/or complex inclusions within the first thermoplastic polymer.

Suitable diameters of the particles of the dispersed second thermoplastic polymer are diameters which are below the diameter of the fiber used in combination with the thermoplastic composition according to the invention for the use in ballistic applications.

Preferably, the diameter of the particles of the dispersed second thermoplastic polymer is in the range of 0.01 μm to 15 μm in diameter, preferably 5 μm to 15 μm in diameter and most preferably 10 μm to 15 μm.

The diameter of the particles, in the case where the dispersed first thermoplastic polymer is present as elongated spheroid shaped particles, ellipsoids, network of branched filament-like structures and/or complex inclusions, is the smallest straight line or minor axis length (average cross-sectional diameter) that can be traced within the limits of the ellipsoids and inclusions, respective is the average diameter of the elongated spheroid shaped particles.

The second thermoplastic polymer according to the present invention can be chosen among polymers, for example, polyvinyls, polyolefins and/or polycondensates, like for example, but not limited to, polyethylene, polyethylene copolymers, polypropylene, polypropylene copolymers, polybutylene, polybutylene copolymers, polyamides, polyamide copolymers, polyesters, polyurethanes, polyurethane copolymers, polyacrylonitrils, polysulfones, thermoplastic silicone copolymers, thermoplastic elastomeric block copolymers, for example, acrylonitrile-butadiene-styrene, polyisopropene-polyethylene-butylene-polystyrene or polystyrene-polyisoprene-polystyrene block copolymers, polyether-ester block copolymers, and/or combinations thereof.

The second thermoplastic polymer suitable for the present invention is preferably chosen among those mentioned polymers having a melting point in the range of 60° C. to 250° C. and more preferably 60° C. to 150° C.

Preferably, the second thermoplastic polymer according to the present invention can be chosen among polymers, for example, thermoplastic elastomeric block copolymers, like for example, but not limited to, polyisopropene-polyethylene-butylene-polystyrene or polystyrene-polyisoprene-polystyrene block copolymers, or, for example, polyolefins, like for example, but not limited to, polyethylenes, for example, low density polyethylenes, very low density polyethylenes, metallocene polyethylenes and/or polyethylene copolymers, for example, ethylene/α,β-unsaturated C3-C8 carboxylic acid copolymers and/or ethylene/α,β-unsaturated C3-C8 carboxylic acid copolymers partially neutralized with metal salts.

More preferably, the second thermoplastic polymer according to the present invention can be chosen among polyethylene copolymers, for example, ethylene/α,β-unsaturated C3-C8 carboxylic acid copolymers and/or ethylene/α,β-unsaturated C3-C8 carboxylic acid copolymers partially neutralized with metal salts.

In the case where the second thermoplastic polymer is an ethylene/α,β-unsaturated C3-C8 carboxylic acid copolymer, the α,β-unsaturated C3-C8 carboxylic acid can be chosen from acrylic acid and/or methacrylic acid.

The ethylene/α,β-unsaturated C3-C8 carboxylic acid copolymer is preferably a terpolymer of ethylene, α,β-unsaturated C3-C8 carboxylic acid and α,β-unsaturated C3-C8 dicarboxylic acid.

The α,β-unsaturated C3-C8 dicarboxylic acid can be chosen from maleic acid, maleic anhydride, C1-04 alkyl half esters of maleic acid, fumaric acid, itaconic acid and itaconic anhydride. Preferably, the α,β-unsaturated C3-C8 dicarboxylic acid can be chosen from maleic anhydride, ethyl hydrogen maleate and methyl hydrogen maleate. Most preferably, the α,β-unsaturated C3-C8 dicarboxylic acid is maleic anhydride, methyl hydrogen maleate and/or combinations thereof.

The ethylene/α,β-unsaturated C3-C8 carboxylic acid/α,β-unsaturated C3-C8 dicarboxylic acid polymer can further comprise up to 40 weight percent of an C1-08 alkyl acrylate softening comonomer, which is preferably chosen among methyl (meth)acrylate, ethyl (meth)acrylate or n-butyl (meth)acrylate, more preferably from n-butyl acrylate or ethyl (meth)acrylate.

The term softening comonomer as mentioned in this description is well-known to those skilled in the art and refers to comonomers such as the C1-08 alkyl acrylate mentioned above.

The term (meth)acrylate as mentioned in this description is respectively intended to mean acrylate and methacrylate.

In the ethylene/α,β-unsaturated C3-C8 carboxylic acid/α,β-unsaturated C3-C8 dicarboxylic acid polymer, the α,β-unsaturated C3-C8 carboxylic acid can be present in a range of 2 to 25 weight percent and the α,β-unsaturated C3-C8 dicarboxylic acid can be present in a range of 0.1 to 15 weight percent with the proviso that the α,β-unsaturated C3-C8 carboxylic acid and the α,β-unsaturated C3-C8 dicarboxylic acid are present from 4 to 26 weight percent, and with the further proviso that the total comonomer content, including the C1-C8 alkyl acrylate softening comonomer, does not exceed 50 weight percent.

Most preferably, the second thermoplastic polymer according to the present invention is an ethylene/α,β-unsaturated C3-C8 carboxylic acid copolymer partially neutralized with metal ions, which is commonly referred to as “ionomer”. The total percent neutralization is from 5 to 90 percent, preferably 10 to 70 percent, most preferably between 25 and 60 percent of the ionomer.

In the case where the second thermoplastic polymer is an ethylene/α,β-unsaturated C3-C8 carboxylic acid copolymer partially neutralized with metal ions, the α,β-unsaturated C3-C8 carboxylic acid can be chosen from acrylic acid and/or methacrylic acid. The ethylene/α,β-unsaturated C3-C8 carboxylic acid copolymer partially neutralized with metal ions is preferably a terpolymer of ethylene, α,β-unsaturated C3-C8 carboxylic acid and α,β-unsaturated C3-C8 dicarboxylic acid partially neutralized with metal ions.

The α,β-unsaturated C3-C8 dicarboxylic acid can be chosen from the same components as already described above.

The ethylene/α,β-unsaturated C3-C8 carboxylic acid/α,β-unsaturated C3-C8 dicarboxylic acid polymer partially neutralized with metal ions can further comprise up to 40 weight percent of an C1-08 alkyl acrylate softening comonomer, which is preferably chosen among the same components as already described above.

In the ethylene/α,β-unsaturated C3-C8 carboxylic acid/α,β-unsaturated C3-C8 dicarboxylic acid polymer partially neutralized with metal ions, from 5 to 90 percent of the total number of α,β-unsaturated C3-C8 carboxylic acid units in the polymer are neutralized with metal ions, and the α,β-unsaturated C3-C8 carboxylic acid and the α,β-unsaturated C3-C8 dicarboxylic acid can be present in the same amounts as described above, with the same proviso regarding the α,β-unsaturated C3-C8 carboxylic acid and the α,β-unsaturated C3-C8 dicarboxylic acid and the same further proviso regarding the total comonomer content, including the C1-C8 alkyl acrylate softening comonomer, as described above.

The ethylene/α,β-unsaturated C3-C8 carboxylic acid copolymer that are partially neutralized are partially neutralized with metal ions which can be any metal ion of group I or group II of the periodic table. In practice however, the preferred metal ions are sodium, zinc, lithium, magnesium, calcium or a mixture of any of these. More preferred are sodium, zinc, lithium and magnesium. Most preferably, the ion is zinc, lithium and/or combinations thereof.

The partially neutralized ethylene/α,β-unsaturated C3-C8 carboxylic acid copolymers according to the present invention may be prepared by standard neutralization techniques, as disclosed in U.S. Pat. No. 3,264,272 which is hereby incorporated by reference. The resulting ionomers may have an melt index (MI) of from 0.01 to 100 grams/10 minutes, preferably 0.1 to 30 grams/10 minutes, as measured using ASTM D-1238, condition E (190° C., 2160 gram weight).

The above ionomers can be prepared by free-radical copolymerization methods, using high pressure, operating in a continuous manner known in the art, as described in U.S. Pat. No. 4,351,931, U.S. Pat. No. 5,028,674, U.S. Pat. No. 5,057,593, U.S. Pat. No. 5,859,137.

The thermoplastic composition according to the present invention can be produced by adding the second thermoplastic polymer to the first thermoplastic polymer, such that the second thermoplastic is dispersed in a continuous or co-continuous phase of the first thermoplastic or that the first thermoplastic is dispersed in a continuous or co-continuous phase of the second thermoplastic

The successful use of the thermoplastic composition according to the present invention for manufacturing personal protection equipment (PPE) relies mainly on the fact that the first or second thermoplastic polymer, which has utility in the manufacturing of personal protection equipment (PPE), is dispersed in a continuous or co-continuous phase of the first or second thermoplastic polymer, as described above. Preferred is a thermoplastic composition according to the invention comprises the first thermoplastic polymer dispersed in the continuous or co-continuous phase of the second thermoplastic polymer.

It is desirable according to the present invention to have the highest possible amount of the second thermoplastic polymer in the thermoplastic composition according to the invention.

Therefore, the thermoplastic composition can comprise from 30 to 99 weight percent of the second thermoplastic polymer, the weight percent based on the total weight of the thermoplastic composition. Preferably, the thermoplastic composition according to the present invention comprises from 30 to 75 weight percent of the second thermoplastic polymer. More preferably, the thermoplastic composition according to the present invention comprises from 40 to 75 weight percent of the second thermoplastic polymer, based on the total weight of the thermoplastic composition. The thermoplastic composition can comprise from 1 to 70 weight percent of the first thermoplastic polymer, the weight percent based on the total weight of the thermoplastic composition. Preferably, the thermoplastic composition according to the present invention comprises from 25 to 70 weight percent of the first thermoplastic polymer.

More preferably, the thermoplastic composition according to the present invention comprises from 25 to 60 weight percent of the first thermoplastic polymer.

In addition, the thermoplastic composition may optionally comprise reactive or non-reactive additives such as, but not limited to, colorants, diluents, processing agents, UV additives, fire retardants, mineral fillers, organic fillers, bonding additives, surfactants, aramid pulp, antioxidants, antistatic, slip agents, tackifiers, plastifiers, and/or combinations thereof as known in the art and which can be incorporated by known methods.

Fire retardants may be chosen from brominated flame retardants, red phosphorus, asbestos, antimony trioxide, borates, metal hydrates, metal hydroxides, Tetrakis(hydroxymethyl)phosphonium salts, fluorocarbons and/or combination thereof.

The thermoplastic composition according to the present invention can be obtained by blending the first thermoplastic polymer and the second thermoplastic polymer and can result in various forms such as, but not limited to, pellets, fibers, sheets, fabrics, hotmelts, powders, liquids, and/or combinations thereof. For example, the blending can be done by using a kneader or a single or twin screw extruder, using a melt temperature of between 80° C. to 420° C., or in heated melt mixer at a temperature of between 80° C. to 420° C.

The present invention further provides a personal protection equipment (PPE) comprising at least one ballistic fabric and a thermoplastic composition, wherein the thermoplastic composition is a composition as described above and wherein the at least one ballistic fabric is reinforced with said thermoplastic composition.

Suitable ballistic fabrics are fabrics comprising fibers having at least a tenacity of 150 g/tex, and a tensile modulus of at least 400 g/tex. Preferably, the fibers have at least a tenacity of 200 g/tex, and a tensile modulus of at least 5000 g/tex.

The ballistic fabric according to the present invention can be a woven, knit or non-woven fabric. Preferably, the ballistic fabric is a woven fabric.

Woven fabrics include, but are not limited to, fabrics woven with plain, basket, twill, satin and other complex weaves including, but not limited to, unidirectional, quasi unidirectional, multi-axial weaves and three dimensional materials, alone or in combination.

In a unidirectional fabric the yarns all run in the same direction. In a quasi-unidirectional fabric the yarns may be laid in more than one direction and some yarns are not totally flat. As used herein, “unidirectional” encompasses both unidirectional and quasi-unidirectional fabric, unless the context requires otherwise.

Non-woven fabrics include, but are not limited to, needle felts, hydroentangled felts, meltblown and/or spunbonded fabrics.

The fiber material to form the at least one ballistic fabric can be chosen among aromatic polyamide fibers, such as for example, but not limited to, poly-paraphenylene terephthalamide (commercially available as Kevlar® from DuPont de Nemours), poly-metaphenylene terephthalamide (commercially available as Nomex® from DuPont de Nemours) and, liquid crystalline polymer and ladder-like polymer fibers, for example, polybenzimidazoles or polybenzoxazoles, especially poly-para-phenylene-2,6-benzobisoxazole (PBO), 5-amino-2-(p-aminophenyl)-benzimidazole, or poly(2,6-diimidazo[4,5-b-4,5-e]pyridinylene-1,4-(2,5-dihydroxy)phenylene) (PIPD; also referred to as M5) fibers, highly oriented polyolefin fibers, for example, high molecular weight polyethylene (HMPE) fibers, polypropylene fibers, ballistic nylons high strength mineral fibers, for example, glass fibers, basalt fibers and/or combinations thereof, provided that the ballistic fabric meets the ballistic performance requirements, as known to those skilled in the art.

Preferably, the fiber material can be chosen among highly oriented polyolefin fibers, aromatic polyamide fibers, PBO fibers, PIPD fibers or glass fibers, and/or combinations thereof.

More preferably, the fiber material is poly-paraphenylene terephthalamide (commercially available as Kevlar® from DuPont de Nemours) or poly-metaphenylene terephthalamide (commercially available as Nomex® from DuPont de Nemours).

According to the present invention, the at least one ballistic fabric is reinforced with the thermoplastic composition which has already been described in detail in the previous section of the present application.

The reinforcement of the at least one ballistic fabric with the thermoplastic composition can be achieved by applying the thermoplastic composition the ballistic fabric using methods known in the art, such as, but not limited to, lamination, calendaring, heat pressing, powder impregnation, liquid impregnation, extrusion coating, and/or combinations thereof. Preferably, the reinforcement of the at least one ballistic fabric is achieved by lamination with the thermoplastic composition of the present invention.

The thermoplastic composition according to the present invention can be applied in various forms such as, but not limited to, sheets, fabrics, hotmelts, powder, liquids, and/or combinations thereof.

Preferably, the thermoplastic composition is applied as a sheet having a thickness of 10 μm to 200 μm. More preferably, the thermoplastic composition is applied as a sheet having a thickness of 30 μm to 150 μm. Most preferably, the thermoplastic composition is applied as a sheet having a thickness of 40 μm to 100 μm.

The temperature at which the at least one ballistic fabric is reinforced with the thermoplastic composition must be at least at or above the melting point of the highest melting thermoplastic polymer in the thermoplastic composition, with the proviso that the temperature at which the ballistic fabric is reinforced with the thermoplastic composition does not exceed a temperature that damages the ballistic fiber.

These damaging temperatures are well known in the art, and are, for example, at 230° C. for aramids, 140° C. for high molecular weight polyethylene (HMPE), 300° C. for PBO and 450° C. for glass fiber or PIPD.

According to the present invention, a plurality of the reinforced ballistic fabric layers can be assembled into a personal protection equipment according to the invention comprising a plurality of the reinforced ballistic fabric layers.

Preferably, the individual reinforced fabric layers of the personal protection equipment according to the invention are not connected between them in a way that restricts their relative movement to each other, but in a way to form a stack of free individual reinforced fabric layers of the invention. This can be done, for example, by stacking the fabric layers on top of each other and placing them into pouches or bags. Thus each individual reinforced fabric layer of the invention is able to move with respect to other fabric layers, within the plane defined by that individual reinforced fabric layer of the invention.

Additionally and for specific applications, the individual reinforced fabric layers of the personal protection equipment can be connected to each other by tacking, sewing, taping or gluing on the periphery of the fabric layers.

The multilayered ballistic protection system may even further comprise at least one layer of steel, aluminum, titanium, and alloys thereof, ceramics, glasses, and/or combinations thereof.

The multilayered ballistic protection system may be useful in different applications where protection is sought against multiple threats, such as for example knife and spike threats, but also against ballistic threats, in garments or articles such as for example, ballistic rated body armor.

An advantage of using the thermoplastic composition according to the present invention in PPEs is that the shelf life is almost unlimited for ballistic fabrics pre-impregnated with said thermoplastic composition, in contrast to ballistic fabrics pre-impregnated with curable thermoset resins widely used in the art of ballistic protection systems, which have a limited shelf life. Ballistic fabrics pre-impregnated with curable thermoset resins slowly cure even when stored at cool temperatures, which is why they need to be processed quickly after pre-impregnation. In addition, thermoset resins heavily used in the field, such as phenolic resins, liberate VOCs (Volatile Organic compounds) and require additional venting of the storage spaces and additional safety measures during processing.

Also, curable materials such as epoxy resins or phenolic resins are much more rigid than the thermoplastic compositions according to the present invention, which adds to the discomfort felt by the wearer.

Without wishing to be held to particular theory, the first thermoplastic polymer acts as a softening agent by interrupting the otherwise continuous phase of second thermoplastic polymer. Instead of embedding the fibers with a pure second thermoplastic polymer, the first thermoplastic polymer of the thermoplastic composition according to the present invention will create interruptions in the otherwise homogenous second thermoplastic. This creates a network-like phase of second thermoplastic polymer which will not therefore contact the entirety of the fiber surface because it is partly displaced by the first thermoplasticpolymer, which results in unexpected benefit of increased flexibility of the reinforced fabric layer according to the present invention.

The present invention further provides for a ballistic fabric that is reinforced with a thermoplastic composition, which can be particularly useful in manufacturing thermoformed personal protection equipment suited for female anatomy.

The present invention is further defined in the following Examples. It should be understood that these examples are given by way of illustration only.

### EXAMPLES

### Example 1 (Comparative)

Poly-p-phenylene terephtalamide yarns having a linear density of 1100 dtex were woven into a plain weave fabric having 8.5 ends/cm (warp) and 8.5 ends/cm (weft) and were subsequently laminated with a ionomer blown film having a thickness of 55 μm to yield a laminated para-aramid woven layer.

The ionomer was a copolymer of ethylene and 19 wt-% MAA (methacrylic acid), wherein 45% of the available carboxylic acid moieties were neutralized with sodium cations and having melting point of 98° C. (product supplied by E. I. du Pont de Nemours and Company, Wilmington, Del. under the trademark Surlyn®).

Poly-p-phenylene terephtalamide yarns are commercially available from E.I. du Pont de Nemours and Company (Wilmington, USA) under the trade name Kevlar® 1K1533.

30 layers of para-aramid laminated fabric where freely assembled together by stacking them and inserting the stack into a pouch having one 3 mm thick backing layer made of PU foams having an areal density of 100 g/m2 to form a multilayered pack having a total areal density of 7.319 kg/m2. The multilayered pack was then conditioned at 25° C. for 24 hours at 55% RH before being subjected to several tests.

### Example 2

Poly-p-phenylene terephtalamide yarns having a linear density of 1100 dtex were woven into a plain weave fabric having 8.5 ends/cm (warp) and 8.5 ends/cm (weft) and were subsequently laminated with a total of two ionomer blown films having a thickness of 55 μm, by laminating one ionomer film onto each side of the fabric, to yield a laminated para-aramid woven layer.

The ionomer was a copolymer of ethylene and 19 wt-% MAA (methacrylic acid), wherein 45% of the available carboxylic acid moieties were neutralized with sodium cations and having melting point of 98° C. (product supplied by E. I. du Pont de Nemours and Company, Wilmington, Del. under the trademark Surlyn®).

23 layers of para-aramid laminated fabric where freely assembled together by stacking them and inserting the stack into a pouch having one 3 mm thick backing layer made of PU foams having an areal density of 100 g/m2 to form a multilayered pack having a total areal density of 6.556 kg/m2. The multilayered pack was then conditioned at 25° C. for 24 hours at 55% RH before being subjected to several tests.

### Example 3

Preparation of a Laminated Para-aramid Woven Layer

Poly-p-phenylene terephtalamide yarns having a linear density of 1100 dtex were woven into a plain weave fabric having 8.5 ends/cm (warp) and 8.5 ends/cm (weft) and were subsequently laminated with a Nylon/Ionomer blown film having a thickness of 55 μm to yield a laminated para-aramid woven layer.

The Nylon/Ionomer having a melting point of 178° C. film was composed of 55% Nylon 12 by weight, commercially available from Arkema under the trademark Rilsan AESNO and having a melting point of 180° C., and of 45% by weight of a zinc ionomer having a melting point of 95° C. and having a neutralisation percentage of 60% and composed of ethylene (83% by weight) , methacrylic (11% by weight) acid and maleic acid anhydride (6% by weight), based on the weight of the thermoplastic composition. 30 layers of para-aramid laminated fabric where freely assembled together by stacking them and inserting the stack into a pouch having one 3 mm thick backing layer made of PU foams having an areal density of 100 g/m2 to form a multilayered pack having a total areal density of 7.150 kg/m2. The multilayered pack was then conditioned at 25° C. for 24 hours at 55% RH before being subjected to several tests.

### Example 4

Poly-p-phenylene terephtalamide yarns having a linear density of 1100 dtex were woven into a plain weave fabric having 8.5 ends/cm (warp) and 8.5 ends/cm (weft) and were subsequently laminated with of two Nylon/Ionomer blown films having a thickness of 55 μm, by laminating one ionomer film onto each side of the fabric, to yield a laminated para-aramid woven layer.

The Nylon/ionomer having a melting point of 178° C. film was composed of 55% Nylon 12 by weight, commercially available from Arkema under the trademark Rilsan AESNO and having a melting point of 180° C., and of 45% by weight of a zinc ionomer having a melting point of 95° C. and having a neutralisation percentage of 60% and composed of ethylene (83% by weight) , methacrylic (11% by weight) acid and maleic acid anhydride (6% by weight), based on the weight of the thermoplastic composition.

23 layers of para-aramid laminated fabric where freely assembled together by stacking them and inserting the stack into a pouch having one 3 mm thick backing layer made of PU foams having an areal density of 100 g/m2 to form a multilayered pack having a total areal density of 6.413 kg/m2. The multilayered pack was then conditioned at 25° C. for 24 hours at 55% RH before being subjected to several tests.

### Example 5

Preparation of a Laminated Para-aramid Woven Layer

Poly-p-phenylene terephtalamide yarns having a linear density of 1100 dtex were woven into a plain weave fabric having 8.5 ends/cm (warp) and 8.5 ends/cm (weft) and were subsequently laminated with a Nylon/Ionomer blown film having a thickness of 55 μm to yield a laminated para-aramid woven layer.

The Nylon/Ionomer film was composed of 55% Nylon 12, commercially available from Arkema under the trademark Rilsan AESNO and having a melting point of 180° C., and of 45% by weight of a zinc ionomer having a neutralisation percentage of 58% and composed of ethylene (85% by weight) and methacrylic (acid 15% by weight) and having melting point of 93° C., based on the weight of the thermoplastic composition.

30 layers of para-aramid laminated fabric where freely assembled together by stacking them and inserting the stack into a pouch having one 3 mm thick backing layer made of PU foams having an areal density of 100 g/m2 to form a multilayered pack having a total areal density of 7.15 kg/m2.

Knife and Spike Resistance Test

The multilayered packs comprising the freely assembled stacks manufactured according to example 1,2,3,4 and 5 were subjected to knife and spike resistance tests according to the HOSDB Body armour Standards for UK Police (2007) Part 3 from the United Kingdom Home Office, Scientific Development Branch, using a P1 B test blade having 24 (KR1) and 36 (KR2) joules of attacking energy, and also using a SPB (100 mm) test spike at 24 joules (SP1) attacking energy for a number of 5 drops of the same blade. The KR1 level is passed if the blade penetrates less than 8 mm in to the pack. The KR2 level is passed if the blade penetrates less than 20 mm in to the pack. The PB1 level is passed if the blade penetrates less than 1 mm in to the pack.

Results were recorded and are summarized (in millimetres) below in Table 1.

TABLE 1
Penetration depth according HOSDB Body armour Standards
for UK Police (2007) Part 3 (in millimetres)

| | Level | | |
|---|---|---|---|
| | KR1/E1 | KR1/E2 | SP1 |
| Energy | 24 J | 36 J | 24 J |
| Example 1 | 0/0/0/0/0 | 1/5/7/5/10 | 0/0/0/0/0 |
| Example 2 | 3/3/2/2/3 | 11/13/12/14/9 | 0/0/0/0/0 |
| Example 3 | 0/0/5/5/0 | 15/15/12/12/15 | 0/0/0/0/0 |
| Example 4 | 3/7/5/5/5 | 16/15/17/17/17 | 0/2/0/0/1 |
| Example 5 | 0/0/0/0/0 | 4/5/5/8/6 | 0/0/0/0/0 |

As can be seen, the fabrics laminated with the blends according to the invention pass the KR1/E1 level, the KR1/E2 level and the SP1 level as well, except for Example 4 which failed at the SP1 level.

Ballistic Tests (V50)

The multilayered packs comprising the freely assembled stacks manufactured according to example 1,3 and 5 were subjected to ballistic resistance testing to using the V50 assessment with a 9 mm FMJ RN (Full Metal Jacket Round Nose) bullet. Results were recorded and are summarized (in metres per second) in Table 2.

TABLE 2
V50 Measurement 9 mm FMJ RN Remington
(in metres per second)

| | |
|---|---|
| Example 1 | 515 |
| Example 3 | 507 |
| Example 5 | 485 |

As can be seen in Table 2, the V50 values confer sufficient protection against 9 mm FMJ Remington projectiles when they are shot from a handgun, since the muzzle velocities of such projectiles are in the range of 390 to 410 meters per second.

Ballistic Tests (Backface Deformation)

The multilayered packs comprising the freely assembled stacks manufactured according to example 1, 3 and 5 were subjected to backface deformation tests. The backface deformation was measured according the US NIJ 0101.04 standard for S Police (June 2001) with a 9 mm FMJ RN bullet from Remington at 436 m/s. If the backface deformation is less than 44 mm, the test is considered to be passed.

Results were recorded and are summarized (in millimetres) in Table 3.

TABLE 3
Backface Deformation according NIJ 0101.04 Standard
9 mm FMJ RN Remington at 436 m/s (in millimetres)

| | mm |
|---|---|
| Example 1 | 4/4/8 |
| Example 3 | 9/13/18 |
| Example 5 | 13/6/16 |

As can be seen, the fabrics laminated with the blends according to the invention pass the backface deformation test.

Ballistic Tests (Ricochet Occurrence)

The multilayered packs comprising the freely assembled stacks manufactured according to example 1, 3 and 5 were subjected to ricochet occurrence tests. Ricochet occurrence was tested according to NIJ 0101.04 Standards for US Police (June 2001) with a 9 mm FMJ RN bullet from Remington at 390 m/s and at an angle of 30 degrees.

A ricochet was considered not to have occurred when the bullet remained stuck in the multilayered ballistic pack, instead of slipping out and being redirected.

Results were recorded and are summarized in Table 4.

TABLE 4
Occurrence of ricochets 9 mm FMJ RN Remington at 390 m/s

| | Angle 30° |
|---|---|
| Example 1 | slip out/slip out |
| Example 3 | slip out/slip out |
| Example 5 | held/held |

As can be seen, the fabrics laminated with the blends according to the invention prevent the bullet from ricocheting in angle shots.

Static Flexibility Test

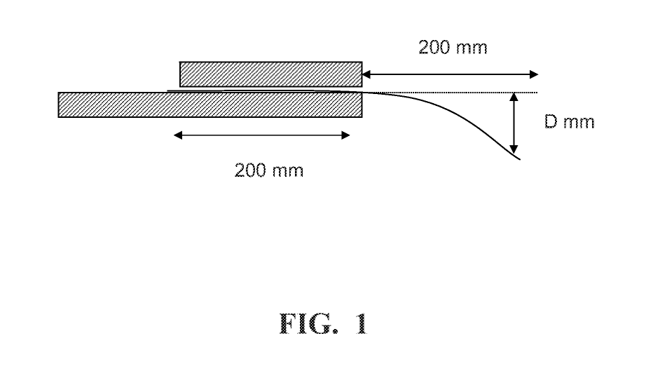

Individual laminated fabric layers manufactured according to example 1, 2, 3, 4 and 5 were subjected to a static flexibility test. The test samples were square-shaped individual laminated fabrics of 400 mm×400 mm. The layers were fixed on the edge of an horizontal table in a manner such as to have half of the area of the fabric (200×400 mm) freely overhanging the edge of the table, as depicted in FIG. 1. Each fabric was tested for a first orientation, rotated by 90° and then tested again. The distance D, which corresponded to the distance in millimetres between the bottom most tip of the tested fabric and the plane of the table, was recorded for each fabric. From these, the angles of deflexion were computed and are summarised in Table 5.

The test consist in measuring the angle of deflection of the layer. Results are reported in table 5

TABLE 5
flexibility test

| | Flex 0° angle | Flex 90° angle |
|---|---|---|
| | of deflection | of deflection |
| Example 1 | 20.3 | 6.8 |
| Example 2 | 19.5 | 4.5 |
| Example 3 | 33 | 29 |
| Example 4 | 33 | 32 |
| Example 5 | 23 | 21 |

As can be seen in Table 5, single fabric layers manufactured according examples 3, 4 and 5 using a blend of ionomer and polyamide show increased angle of deflection when compared to single fabric layers manufactured according to examples 1 or 2 using pure ionomer. In particular, it can be seen that single fabric layers manufactured according examples 3 or 4 show increased angle of deflection when compared to single fabric layers manufactured according to examples 5. Furthermore, single fabric layers manufactured according examples 3 or 4 show excellent angles of deflection for both 0° and 90° rotations in comparison to single fabric layers manufactured according examples 1 or 2, which show a strong dependency on the rotation.

Dynamic Flexibility Test

30 individual laminated fabric layers manufactured according to example 1 and 3 were subjected to a dynamic flexibility test at 19° C. and at 30% relative humidity. The test samples were stacks of 30 square-shaped individual laminated fabrics of 400 mm×400 mm. The stack consisting of 30 square-shaped individual laminated fabrics was placed on top of a polyethylene block having a thickness of 5 cm and having a hole with a diameter of 15 cm in its centre, located in a dynamometer (MTS 10ME) and then subjected to a descending piston having a diameter of 5 cm and a hemispherical point. The force necessary to plunge the piston into the stack of layers through the hole of the polyethylene block to a depth of 40 mm, at a rate of 50 mm per minute, was recorded. The higher the force necessary to push the sample stack through the hole of the polyethylene block, the less flexible the sample is. Table 6 shows the force (in Newton) at a depth of 30 mm for the 30 individual laminated fabrics manufactured according to Example 1 and 3.

TABLE 6

| | Force at 30 mm in Newton |
|---|---|
| Example 1 (30 layers) | 3971 |
| Example 3 (30 layers) | 2004 |

As can be seen in Table 6, the stack of 30 fabric layers laminated with an ionomer according to Example 1 shows an increased rigidity of about twofold when compared to a stack of 30 fabric layers laminated with a Nylon/Ionomer blend according to Example 3.

What is claimed is:

1. Thermoplastic composition for manufacturing a personal protection equipment for personal ballistic, stab and knife protection, wherein the thermoplastic composition comprises at least a first thermoplastic polymer and at least a second thermoplastic polymer, wherein the first thermoplastic polymer has a melting point different to the melting point of a second thermoplastic polymer.

2. The thermoplastic composition according to claim 1, wherein the second thermoplastic polymer is present from 30 to 99 weight percent, the weight percent being based on the total weight of the thermoplastic composition.

3. The thermoplastic composition according to claim 1, wherein the first thermoplastic polymer comprises amorphous polyamides from 1 to 50 weight percent based on the total weight of the first thermoplastic polymer.

4. The use of a thermoplastic composition according to any preceding claim, wherein the first thermoplastic polymer is present from 25 to 70 weight percent, the weight percent being based on the total weight of the thermoplastic composition.

5. The use of a thermoplastic composition according to any preceding claim, wherein the first thermoplastic polymer is dispersed in the continuous or co-continuous phase of the second thermoplastic polymer.

6. The use of a thermoplastic composition according to any preceding claim, wherein the second thermoplastic polymer is present from 30 to 75 weight percent based on the total weight of the thermoplastic composition.

7. A personal protection equipment comprising
a. a plurality of ballistic fabric layers and;
b. at least one thermoplastic composition for use in ballistic applications, wherein the thermoplastic composition comprises at least a first thermoplastic polymer that has a melting point different to the melting point of a second thermoplastic polymer, and
wherein at least one of the ballistic fabric layers is reinforced with the thermoplastic composition, and wherein the ballistic fabric layers comprising the at least one reinforced ballistic fabric layers are connected between them to form a stack of free individual ballistic fabric layers by stacking the fabric layers on top of each other and placing them into pouches or bags.

8. The personal protection equipment according to claim 7, wherein the ballistic fabric layer reinforced with the thermoplastic composition is able to move with respect to each other fabric layers, within the plane defined by the reinforced fabric layer.

9. The personal protection equipment according to claim 4, wherein the second thermoplastic polymer is present from 30 to 99 weight percent, the weight percent being based on the total weight of the thermoplastic composition.

10. The personal protection equipment according to claim 4, wherein the first thermoplastic polymer comprises amorphous polyamides from 1 to 50 weight percent based on the total weight of the first thermoplastic polymer.

11. A reinforced ballistic fabric comprising a ballistic fabrics and a thermoplastic composition comprising at least a first thermoplastic polymer and at least a second thermoplastic polymer, wherein the first thermoplastic polymer has a melting point different to the melting point of a second thermoplastic polymer.

12. The reinforced ballistic fabric according to claim 11, wherein the second thermoplastic polymer is present from 30 to 99 weight percent, the weight percent being based on the total weight of the thermoplastic composition.

13. The reinforced ballistic fabric according to claim 11 or 12, wherein the first thermoplastic polymer is present from 25 to 70 weight percent, the weight percent being based on the total weight of the thermoplastic composition.

14. The reinforced ballistic fabric according to claim 11, 12 or 13, wherein the first thermoplastic polymer is dispersed in the continuous or co-continuous phase of the second thermoplastic polymer.
